(19) United States
(12) Patent Application Publication
(10) Pub. No.: US 2014/0280079 A1
(43) Pub. Date: Sep. 18, 2014

(54) Creating Lists of Digital Content

(71) Applicant: Google Inc., Mountain View, CA (US)

(72) Inventors: Ankit Jain, Milpitas, CA (US); Anna Patterson, Saratoga, CA (US)

(21) Appl. No.: 13/800,915

(22) Filed: Mar. 13, 2013

(51) Int. Cl. G06F 17/30

(52) U.S. Cl. CPC G06F 17/3053
USPC 707/723

(57) ABSTRACT

A server system, which manages distribution or download of content, may be configured to distribute content lists generated by users. In this regard, the server system may allow users to follow other users and/or particular individual content lists that may be made available by the server system. Accordingly, users of the server system may be allowed to become list producers and/or list followers. Distribution of the content lists may be based on one or more of: an indication by a user of a selection to follow another user, a match between user search criteria specified by the user and at least some of the data associated with the other user, a match between list search criteria specified by the user and at least some of the data of distributed list(s), and a match between the particular user recommendation ranking and ranking criteria specified by the user.

### TECHNICAL FIELD

Aspects of the present application relate to distribution of content. More specifically, certain implementations of the present disclosure relate to creating lists of digital content that can be followed.

### BACKGROUND

Various types of electronic devices are commonly used nowadays. In this regard, electronic devices may be used by one or more users, for various purposes, including both personal and commercial. Electronic devices may be mobile or non-mobile, may support communication (wired and/or wireless), and/or may be general or special-purpose devices. Examples of electronic devices comprise handheld mobile devices (e.g., cellular phones, smartphones, and/or tablets), computers (e.g., laptops, desktops, and/or servers), and/or other similar devices. In some instances, electronic devices may be used in accessing and/or using content. For example, content may comprise applications, including applications intended for recreational use (e.g., games) and applications intended for personal or business use (e.g., shopping, purchases, banking, scheduling, navigation, and the like); multimedia content (e.g., music, movies, TV shows, and the like); and/or electronic documents (e.g., online articles, e-books, and the like). Content used in or accessed by electronic device may be obtained online.

Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for creating lists of digital content that can be followed, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 is a block diagram illustrating an example of interactions among users and a server for distribution of lists of digital content curated by particular user(s) and followed by other users.

FIG. 2 is a block diagram illustrating an electronic device that may support curating lists of digital content.

FIG. 3 is a block diagram illustrating a content management server that may support distribution of curated lists of digital content.

FIG. 4 is a flow chart that illustrates example process for distributing curated lists of content from list curators to list followers.

### DETAILED DESCRIPTION

The present disclosure relates to a method and system for creating lists of digital content that can be followed. In various implementations, user-curated lists of content may be shared by list curators with list followers, to enable list followers to search for and/or identify content that may be of interest to the list followers. In this regard, while the lists of content may sometimes be communicated directly from the list curators to the list followers, in some implementations the user-curated lists of content may be shared and/or distributed using centralized content distribution systems. For example, a first user (a ‘list curator’) may generate, using a first electronic device, a content list that may comprise data related to a plurality of content recommended, used, or reviewed by the first user. The first user may then communicate the content list to a server system that may be configured to manage sharing of content related data. Subsequently, a second user (a ‘list follower’) may obtain, using a second electronic device, the content list from the server system, wherein the content list may be distributed to the second user based on one or more of: an indication by the second user of a selection to follow the first user, a match between user search criteria specified by the second user and at least some of the data associated with the first user, a match between list search criteria specified by the second user and at least some of the data of the content list, and a match between the particular user recommendation ranking and ranking criteria specified by the second user. In some instances, users may be both list curators and list followers—i.e., a user may curate lists of content while also following lists of content curated by other users.

In some instances, the server system may associate the content list with a particular user recommendation ranking being assigned to the first user. In this regard, the server system may determine and/or assign the particular user recommendation ranking to the first user by the server system. For example, the particular user recommendation ranking may be determined based on one or both of: information related to the first user and feedback information pertaining to the first user that is provided by one or more other users. In some instances, content lists uploaded into and/or communicated to the server system may be stored in a database maintained or accessed by the server system. The second user may select, based on the obtained content list, content that may be available or offered for distribution. In this regard, the server system may offer and/or distribute at least some content associated with the content list, and in some instances, at least some of the content selected by the second user may be obtained from the server system.

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “e.g.,” introduces a list of one or more non-limiting examples, instances, or illustrations.

FIG. 1 is a block diagram illustrating an example of interactions among users and a server for distribution of lists of digital content curated by particular user(s) and followed by other users. Referring to FIG. 1 there is shown electronic devices 100₁ and 100₂, and a content management server 110.

Each electronic device 100 may comprise suitable circuitry, interfaces, logic, and/or code for performing, executing or running various operations, functions, applications and/or services. In this regard, the electronic device 100 may perform, execute and/or run operations, functions, applications and/or services based on user instructions and/or pre-configured instructions. Thus, the electronic device 100 may be configure to support or enable (e.g., by use of suitable input/output devices or components) interactions with users, such as to obtain user input and/or to provide user output. In some instances, the electronic device 100 may support communication of data, such as via wired and/or wireless connections, in accordance with one or more supported wireless and/or wired protocols or standards. In some instances, the electronic device 100 may be a handheld mobile device—i.e. intended for use on the move and/or at different locations. In this regard, the electronic device 100 may be designed and/or configured to allow for ease of movement, such as to allow it to be readily moved while being held by the user as the user moves, and the electronic device 100 may be configured to perform at least some of the operations, functions, applications and/or services supported by the device on the move. Examples of electronic devices may comprise handheld devices (e.g., cellular phones, smartphones, and/or tablets), computers (e.g., laptops or desktops), servers, dedicated multimedia devices (e.g., game consoles and portable media players), and/or other similar devices. The disclosure, however, is not limited to any particular type of electronic device.

The content management server 110 may comprise suitable circuitry, interfaces, logic, and/or code for centrally managing content (e.g., applications, games, multimedia, e-books and other online publications, etc.) that may be made available (e.g., for download and/or distribution) to electronic devices, such as the devices 100₁ and 100₂, In this regard, the content management server 110 may be associated with an entity offering content for download (free or by-purchase) to the electronic device 100. Such entities may comprise physical entities and/or logical entities. Examples of entities offering content for download may comprise online stores, content or service providers, and the like. The disclosure, however, is not limited to any particular type of content offering entity. The content management server 110 may comprise a dedicated processing system or general purpose system (e.g., a dedicated server or a PC), which may be configured for use as centralized content manager (e.g., programmed to provide the application management functions described in this disclosure). In some instances, a content manager ‘server’ may actually comprise a plurality of machines, at least some of which may be installed in different locations, and each of which may be utilized to implement distinct or redundant functions associated with application management operations as described in the present disclosure.

In operation, electronic devices, such as the electronic devices 100₁ and 100₂, may be configured to enable or support use of content. Examples of content may comprise, for example, applications (e.g., applications or ‘apps’ that may be configured to run on certain types of devices, such as tablets and/or smartphones), games, multimedia content (e.g., audio and/or video content); and/or electronic documents (e.g., online articles or publications, e-books, and the like). In this regard, ‘use’ of content may comprise executing or running functions or services associated with content, or simply consuming the content (e.g., viewing video content and/or listing to audio content). The disclosure is not limited to any particular type of content, however. In some instances, content may be pre-installed in electronic devices (e.g., the electronic devices 100₁ and 100₂). In other instances, however, content may be accessed, obtained and/or installed, such as in response to actions (e.g., requests) of device users. In this regard, content may be distributed to (or downloaded by) electronic devices, or simply accessed (e.g., real-time) by the electronic devices.

For example, the electronic devices 100₁ and/or 100₂ may use Internet connections (e.g., over wired or wireless links) to access content (i.e. dynamically and/or in real-time) and/or to download (and if necessary, install) content in the electronic device 100 (e.g., for present and future use). In this regard, content may be offered for access and/or download (for free or by-purchase) by centralized content distributers (e.g., online stores, content or service providers, and similar entities), using content distribution systems or platforms (e.g., the content management server 110), which may be configured to handle the activities relating to the distribution or access of content (e.g., handling user requests, storage of distributed/accessed content, and/or communication of content or information relating thereto). More recently, content distributed in this manner has more often comprised content (e.g., applications) configured for such devices as smartphones, tablets, and the like. In this regard, with explosive growth in the use of such devices, content configured to run on or be accessed by these devices are becoming more ubiquitous, with many centralized content distributers offering thousands and millions of content—with some estimates suggesting tens of billions of downloads (particularly of apps) to date.

With the rapid increase in amount of content available for access and/or download, it is becoming increasingly hard for users to discover and/or identify content that may interest them. Accordingly, in various implementations of this disclosure, various techniques may be utilized to optimize the search and/or identification of content that may be of interest to a user. In this regard, content identification may be performed based on user generated and/or controlled lists of content, whose followers (the lists) may be utilized to find content that may be of interest. In other words, content search or identification may be performed by allowing the end-users to follow particular other users who can curate lists of content. Thus, as the lists curators add new content to their lists, others who follow these lists may discover the newly added content more readily than simply searching all the newly offered content which may comprise a lot of content that may not be of interest to the followers (which may result in the content that would of interest remaining uncovered or being missed). Because the choice of list(s) from which content (including newly added content) may be discovered may be selected by the users, the content that would be discovered and outputted (e.g., displayed) in some suitable interface would be extremely appropriate and relevant to the users. Accordingly, users, at large, may be able to identify and discover niche content curated by others interested in that niche and ignore other types of content that may not be of interest. In some instances, users may be list producer (curators) and list follower at the same time.

In an example implementation, the lists of content that are used to optimize the search for content may be distributed using the same systems of platforms used in distributing content (e.g., the content management server 110). For example, the content management server 110 may receive lists of content from particular curators of certain types of lists (e.g., user of electronic device 100₁, who may curate a list of literary content associated with particular plurality of authors). The content management server 110 may process and/or store the received lists of content (e.g., in an internal database). In this regard, processing the received list may comprise identifying particular identifying characteristics associated with the received lists (e.g., the lists' curator(s), type and/or classification of content, currently listed content, etc.).

The content management server 100 may be configured to enable users associated therewith to follow particular lists of content. In this regard, the content management server 110 may receive a search request for particular lists, such as from users who are (or may become) follower of these particular lists. For example, the user of electronic device 100₂ may issue a request to follow particular lists of content, including the list(s) curated by the user of the electronic device 100₁ for example. In this regard, in some instances the to-be-followed lists may be identified expressly (e.g., based on knowledge of the list(s). In other instances, however, the request may simply comprise information (e.g., information identifying particular curators, particular curatorship weight/rank, desired types of content, etc.) which may enable finding possible suitable lists. Once suitable lists are identified (e.g., based applicable search/match criteria) by the content management server 110, the lists of content may be distributed to the following user(s).

FIG. 2 is a block diagram illustrating an electronic device that may be support curating lists of digital content. Referring to FIG. 2 there is shown an electronic device 200.

The electronic device 200 may comprise suitable circuitry, interfaces, logic, and/or code for implementing various aspects of the disclosure. In this regard, the electronic device 200 may correspond to, for example, the electronic devices 100₁ and/or 100₂ of FIG. 1 (i.e., the electronic device 200 may be used to curate lists of content and/or to follow lists of content curated by other user). The electronic device 200 may comprise, for example, a main processor 202, a system memory 204, a communication subsystem 210, an input/output (I/O) subsystem 220, and a content manager 230.

The main processor 202 may comprise suitable circuitry, interfaces, logic, and/or code that may be operable to process data, and/or control and/or manage operations of the electronic device 200, and/or tasks and/or applications performed therein. In this regard, the main processor 202 may configure and/or control operations of various components and/or subsystems of the electronic device 200, by utilizing, for example, one or more control signals. The main processor 202 may enable running and/or execution of applications, programs and/or code, which may be stored, for example, in the system memory 204. Alternatively, one or more dedicated application processors may be utilized for running and/or executing applications (or programs) in the electronic device 200.

The system memory 204 may comprise suitable circuitry, interfaces, logic, and/or code that may enable permanent and/or non-permanent storage, buffering, and/or fetching of data, code and/or other information, which may be used, consumed, and/or processed. In this regard, the system memory 204 may comprise different memory technologies, including, for example, read-only memory (ROM), random access memory (RAM), Flash memory, solid-state drive (SSD), and/or field-programmable gate array (FPGA). The system memory 204 may store, for example, configuration data, which may comprise parameters and/or code, comprising software and/or firmware.

The communication subsystem 210 may comprise suitable circuitry, interfaces, logic, and/or code operable to communicate data from and/or to the electronic device, such as via one or more wired and/or wireless connections. The communication subsystem 210 may be configured to support one or more wired protocols and/or interfaces, and/or one or more wireless protocols and/or interfaces, facilitating transmission and/or reception of signals to and/or from the electronic device 200 and/or processing of transmitted or received signals in accordance with applicable wired or wireless protocols. Examples of wireless protocols or standards that may be supported and/or used by the communication subsystem 210 comprise wireless personal area network (WPAN) protocols, such as Bluetooth (IEEE 802.15); near field communication (NFC) standards; wireless local area network (WLAN) protocols, such as WiFi (IEEE 802.11); cellular standards, such as 2G/2G+ (e.g., GSM/CPRS/EDGE, and IS-95 or cdmaOne) and/or 2G/2G+ (e.g., CDMA2000, UMTS, and HSPA); 4G standards, such as WiMAX (IEEE 802.16) and LTE; Ultra-Wideband (UWB), and/or the like. Examples of wired protocols and/or interfaces that may be supported and/or used by the communication subsystem 210 comprise Ethernet (IEEE 802.2), Fiber Distributed Data Interface (FDDI), Integrated Services Digital Network (ISDN), and Universal Serial Bus (USB) based interfaces. Examples of signal processing operations that may be performed by the communication subsystem 210 comprise, for example, filtering, amplification, analog-to-digital conversion and/or digital-to-analog conversion, up-conversion/down-conversion of baseband signals, encoding/decoding, encryption/decryption, and/or modulation/demodulation.

The I/O subsystem 220 may comprise suitable circuitry, interfaces, logic, and/or code for enabling and/or managing user interactions with the electronic device 200, such as obtaining input from, and/or to providing output to, the device user(s). The I/O subsystem 220 may support various types of inputs and/or outputs, including, for example, video, audio, and/or text. In this regard, dedicated I/O devices and/or components, external to (and coupled with) or integrated within the electronic device 200, may be utilized for inputting and/or outputting data during operations of the I/O subsystem 220. Examples of such dedicated I/O devices may comprise displays, audio I/O components (e.g., speakers and/or microphones), mice, keyboards, touch screens (or touchpads), and the like. In some instances, user input obtained via the I/O subsystem 220, may be used to configure and/or modify various functions of particular components or subsystems of the electronic device 200.

The content manager 230 may comprise suitable circuitry, interfaces, logic, and/or code for managing content and/or content related information in the electronic device 200. In this regard, the content manager 230 may control and/or manage a plurality of content 240 (e.g., applications, games, multimedia content, etc.) and/or various content related operations or functions (e.g., creation, obtainment, distribution, sharing, storage, etc.). In some instances, the content manager 230 may be configured to support use of user-curated lists of content. For example, the content manager 230 may support curating and/or following lists of content, such as based on user input, which may be provided directly (e.g., via the I/O subsystem 220) and/or indirectly (e.g., inferred based on user content related interactions).

In operation, the electronic device 200 may be utilized (e.g., by a device user) for use or consumption of content (e.g., the content 240). For example, the device user may utilize the electronic device 200 (e.g., the I/O subsystem 220) to listen to audio content, view video content, utilize applications, play games, read online articles or e-book, and the like. In some instances, some of the content 240 may be pre-installed on the electronic device 200. In other instances, however, at least some content may be accessed and/or may obtained using the electronic device 200. In this regard, when accessing or obtaining content, the electronic device 200 may setup (e.g., using the communication subsystem 210) connections, such as over available wired and/or wireless links, to suitable content sources (e.g., the content management server 110). The content sources may then be used to access content—i.e., only real-time use/consumption of content, without the ability to maintain local copies, can be stored and used repeatedly and/or subsequently, and/or used to obtain content—i.e., download copies of content that may be stored (e.g., locally in the electronic device, such as in the system memory 204), allowing the device user to utilize content thereafter (repeatedly and/or in desirable conditions—e.g., time, place, etc.).

In instances where content can be accessed and/or obtained via the electronic device 200, the electronic device 200 may be configured to support various mechanisms for allowing and/or enabling selection of content (would-be accessed or obtained). In this regard, while the selection of content may typically be ultimately and/or preferably be based on user input (i.e., user selection of the particular content to be accessed or obtained), it may be desirable to minimize and/or optimize the content search, especially in light of the vast number of options that may be available and/or be continually added in the marketplace. Accordingly, in various implementations, the electronic device 200 may support use of techniques that may enable narrowing down potential content space which may be searched for (or by) the device user. In an example implementation, content search may be narrowed and/or optimized based on use of user-curated lists of content, which may comprise lists of content that particular user(s) may have identified, such as based on one or more criteria, categories, or classifications (e.g., type of content, whether (or not) the content have been used, reviewed and/or recommended, and the like).

For example, the electronic device 200 may be configured for use in curating lists of content by a user of the device (e.g., as described with respect to the electronic device 100₁ of FIG. 1). In this regard, the device user may generate (e.g., using the I/O subsystem 220) a plurality of lists of content, which may then be managed and/or maintained using the electronic device 200 (e.g., using the content manager 230), such as based on user input and/or interactions. For example, the user may directly (e.g., using direct user input—e.g., selection of currently available content) set or modify the content included in particular lists of content. Alternatively, the content included in particular lists of content may be set or modified indirectly, such as based on user content related interactions (e.g., content that the user uses, especially multiple times may automatically be added to particular lists of content). In some instances, the lists of content curated using the electronic device 200 may be forwarded to and/or shared with other users (the list “followers.”) The communication or sharing of the lists of content with the list follower may be done directly (peer-to-peer) or may simply be done by placing copies of the lists of content in a centralized depository (e.g., the content management server 110), from which the list follower may obtain copies of the lists of content. In some instances, forwarding and/or sharing of lists of content may be done whenever a list is created or updated. Furthermore, the forwarding and/or sharing of lists of content may be done either automatically or manually (e.g., based on user commands).

The electronic device 200 may also be configured for use in following lists of content by a user of the device (e.g., as described with respect to the electronic device 100₂ of FIG. 1). In this regard, a user may sometimes be both list curator and list follower (that is curate lists of content, and follow lists of content—e.g., curated by other users). Accordingly, the electronic device 200 may be configured to enable the device user to identify a plurality of lists of content that the user may desire to follow. For example, the user may directly select particular lists of content (e.g., by identifying the lists, such as when lists of content have unique identifiers that may be known by the user, and/or by simply identify particular user whose lists are to be followed). Alternatively, the particular lists of content may be selected indirectly, such as based various information that may be specified by the user (e.g., types of content, search and/or match criteria, match threshold, recommendation rankings of to-be-followed user(s), etc.). In some instances, identifying and/or matching suitable lists of content may be performed directly by the electronic device 200. In other instances, however, the search and matching may be performed by a centralized entity (e.g., the content management server 110), to which the electronic device 200 may communicate a search request (e.g., either direct identification of lists or information that may be used in the search and matching). When followed, new (or modified) lists of content are received by the electronic device 200, and the lists may be output (e.g., displayed) to the device user, such as to enable making selecting of any newly available or identified content. The content may then be accessed or obtained using the electronic device 200, as described above.

FIG. 3 is a block diagram illustrating a content management server that may support distribution of curated lists of digital content. Referring to FIG. 3 there is shown a content management server 300.

The content management server 300 may comprise suitable circuitry, interfaces, logic, and/or code operable to implement various aspects of the disclosure. In this regard, the content management server 300 may correspond to, for example, the application management server 110 of FIG. 1. The content management server 300 may comprise, for example, a main processor 302, a system memory 304, a communication subsystem 310, a content distribution management module 320, and a content database management module 330.

The main processor 302 may comprise suitable circuitry, interfaces, logic, and/or code that may be operable to process data, and/or control and/or manage components, operations or functions of the content management server 300, and/or tasks performed therein. In this regard, the main processor 302 may configure and/or control operations of various components and/or subsystems of the content management server 300, by utilizing, for example, one or more control signals.

The system memory 304 may comprise suitable circuitry, interfaces, logic, and/or code that may enable permanent and/or non-permanent storage, buffering, and/or fetching of data, code and/or other information, which may be used, consumed, and/or processed. In this regard, the system memory 304 may comprise different memory technologies, including, for example, read-only memory (ROM), random access memory (RAM), Flash memory, solid-state drive (SSD), and/or field-programmable gate array (FPGA). The system memory 304 may store, for example, configuration data, which may comprise parameters and/or code, comprising software and/or firmware.

The communication subsystem 310 may be substantially similar to the communication subsystem 210 of FIG. 2 for example. In this regard, the communication subsystem 310 may comprise suitable circuitry, interfaces, logic, and/or code for enabling communicate data or messages from and/or to the content management server 300, via wired and/or wireless connections for example.

The content distribution management module 320 may comprise suitable circuitry, interfaces, logic, and/or code for managing and/or controlling content distribution via the content management server 300. For example, the content distribution management module 320 may be configured to process content requests received from client devices, manage establishing connections with client devices that may be used in distributing requested content, and/or may be configured to perform necessary device/user authentication. In some instances, the content distribution management module 320 may be configured to support distribution of curated lists of content, such as from list creator(s)/curator(s) to list follower(s).

The content database management module 330 may comprise suitable circuitry, interfaces, logic, and/or code for managing, controlling, and/or using a content database 340, which may be maintained in the content management server 300 (e.g., in a partition of the system memory 304). In this regard, the content database 340 may comprise information corresponding to plurality of content that may be made available to a plurality of users (e.g., for download or distribution) through the content management server 300. For example, the content database 340 may comprise a plurality of entries, each corresponding to a particular content, with each entry comprising information pertinent to the associated content (e.g., availability limitations/restriction, cost, etc.). The per-content entries may also comprise user related data—e.g., information identifying user(s) who developed or modified the content, and/or a listing of user(s) who may be authorized (or prohibited) from accessing or obtaining the content. In some instances, the content database 340 may also comprise a portion for use in storing curated lists of content and/or related information.

In operation, the content management server 300 may be configured to allow access and/or distribution of content, such as to a plurality of users (and/or the users' electronic devices) associated with the content management server 300. For example, the content management server 300 may manage a plurality of content, which may be stored within the content management server 300, and/or external to (but accessible by) the content management server 300, and which may be made available for access or download by users. In this regard, the content available in the content management server 300 may be managed, for example, by the content database management module 330, which may utilize the content database 340 to maintain information regarding available content. In some instances, content available in the content management server 300 may be variable—i.e., content may be added, modified or deleted (e.g., by users, content owners/providers, and the like). The distribution (or accessing) of content via the content management server 300 may be managed using, for example, the content distribution management module 320, which may be configured to establish, setup (or terminate) connections to particular users (using links established via the communication subsystem 310). The content distribution management module 320 may then manage the transfer of content (e.g., in accordance with one-time access or download copying of the content). In some instances, the content distribution management module 320 may be configured to authenticate users seeking access or download of content (e.g., to guard against unwanted access).

In some instances, the content management server 300 may be utilized to support use of user-curated lists of content by users associated with the content management server 300. In this regard, the user-curated lists of content may be utilized to enable narrowing content search (for new and/or previously unknown content) by users, as described with respect to FIGS. 1 and 2 for example. For example, the content management server 300 may be utilized to facilitate distribution of user-curated lists, from a list of curators to list followers. In this regard, the content management server 300 may be configured to store and/or make available lists of content, which may be uploaded or communicated by a list curators (e.g., using their electronic devices, such as the electronic device 100₁). In some instances, the lists of content made available via the content management server 300 may be managed in similar manner as with respect to content made available via the content management server 300. The uploaded lists of content may be managed by, for example, the content database management module 330, with the content database 340 being used to store information about the lists (which—that is the information—may be used subsequently in searching for and/or matching lists, such as when requested by list followers). In some instances, the content management server 300 may determine and/or assign for each user uploading lists of content (i.e., each list curator), a particular user recommendation ranking. In this regard, the recommendation ranking may comprise a value selected from a plurality of assignable values (e.g., 0-4), representing (in increasing or decreasing order) the level of trustworthiness of the user recommendation. The recommendation ranking may be determined and/or assigned based on various information, particularly information relating to the user (e.g., number of uploaded, number of following, presence of negative/positive feedback, presence of any indicia of untrustworthiness—e.g., spam practices, etc.). Accordingly, the content management server 300 may associate with each uploaded list of content the user recommendation ranking associated with the list curator.

The content management server 300 may distribute available lists of content to list followers, such as in response to list search requests that may be communicated to the content management server 300 by the list follower (e.g., using their electronic devices, such as the electronic device 100₂). For example, the search request may comprise information that may be used by the content management server 300 to search for and/or match (from available lists of content) particular lists for distribution to the requesting list followers. In this regard, in some instances, distributed lists (if any) may be selected based on express selection or indication by the list follower—e.g., identifying particular users and/or particular lists of content, such as by specifying unique identifiers for the user or lists in instances where such identifiers may be used and are known. In other instances, the search request may simply specify information that may be utilized by the content management server 300 in searching for and/or matching suitable lists of content. For example, the search request may specify particular search criteria that may enable determining the presence of positive match based on one or more of data associated with list curators (e.g., number of lists curated, type of content curated, etc.), data associated with the lists (e.g., type of content, degree of specificity in any reviews or recommendations, etc.). In some instances, the searching and matching may be performed based on ranking—e.g., the search request may specify a ranking criteria (e.g., minimum acceptable ranking) against which the recommendation ranking associated with each possible list may be compared.

In some instances, the content management server 300 may be configured to generate content list related recommendations. The content distribution management module 320 may be operable to generate, for example, content list following recommendations (e.g., comprising information identifying particular users and/or lists that may be followed) for a particular user based on that user content list related interactions. For example, in instances where the content manager server 300 receives a list of content from a first user and distribute that list to a second user, the content manager server 300 may generate content list following recommendation for the first user and/or the second user (identifying other users or lists) based on matching the recommended users and/or lists with the distributed lists and the content preferences associated with the first user or second users (e.g., as determined from the shared list).

FIG. 4 is a flow chart that illustrates example process for distributing curated lists of content from list curators to list followers. Referring to FIG. 4, there is shown a flow chart 400 comprising a plurality of steps for distributing curated lists of content from list curators to list followers, such as via a distribution server (e.g., the content management server 300 of FIG. 3).

In step 402, a list curator may generate or updated (e.g., using an electronic device, such as the electronic device 100₁ of FIG. 1) a list of content, and may send the list to a content distribution server. In this regard, the list of content may identify content that the list curator may have used and/or recommended (including newly used and/or recommended content). In step 404, the content distribution server may receive and process the list of content—e.g., to update a content related database, such as the content database 340, which may store data relating to user curated lists of content. In step 406, the content distribution server may receive a search request from a list follower (i.e., to enable user to follow lists curated by other users). In this regard, the search request may either identify (expressly) particular list(s), such as when lists have associated with them unique identifiers, or by providing information that may enable identifying (indirectly) desired list(s)—e.g., by inclusion of information specifying particular list curator(s), particular curatorship weight/rank, desired types of content, etc. In step 408, the content distribution server may determine if there is any list(s) of content in the database that may match the received search request (e.g., based on applicable search/match criteria). In instances where there may be list(s) of content that matches the received request, the identified lists may be forwarded to the requesting list follower(s). In some instances, the content distribution server may be configured (e.g., based on input by the list curators) to validate that the requesting user(s) may be authorized list follower(s), and may only forward list(s) to the requesting user if confirmed to be an authorized follower. In some instances, updates regarding changes and/or modifications to existing lists of content may be distributed automatically by the content distribution server. For example, list followers may be allowed to request and/or view the latest status of list(s) that list followers are following (e.g., provide a webpage or other types of interfaces that may allow list follower to see what the lists they are following have and/or if anything has been updated, added or removed).

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for creating lists of digital content that can be followed.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method, comprising:
receiving by the server system, from a first user of a first electronic device, a content list that comprises data related to a plurality of content items recommended, used, or reviewed by the first user;
associating by the server system, the content list with a particular user recommendation ranking being assigned to the first user; and
providing by the server system, to a second user using a second electronic device, the content list from the server system, wherein the content list is provided to the second user based on one or more of:
an indication by the second user of a selection to follow the first user,
a match between user search criteria specified by the second user and at least some of the data associated with the first user,
a match between list search criteria specified by the second user and at least some of the data of the content list, and
a match between the particular user recommendation ranking and ranking criteria specified by the second user.

2. The method according to claim 1, comprising storing the content list in a database maintained or accessed by the server system.

3. The method according to claim 1, comprising assigning the particular user recommendation ranking to the first user by the server system.

4. The method according to claim 1, comprising determining the particular user recommendation ranking by the server system.

5. The method according to claim 1, wherein the particular user recommendation ranking is determined based on one or more of: information related to the first user, or feedback information pertaining to the first user that is provided by one or more other users.

6. The method according to claim 1, comprising selecting by the second user based on the content list, a content that is available or offered for distribution.

7. The method according to claim 6, comprising obtaining the selected content from the server system.

8. The method according to claim 1, comprising offering and/or distributing by the server system at least some content associated with the content list.

9. A system, comprising:
a server system that is configured to manage sharing of content related data, wherein the server system is operable to:
receiving from a first user of a first electronic device, a content list that comprises data related to a plurality of content items recommended, used, or reviewed by the first user;
associate the content list with a particular user recommendation ranking assigned to the first user;
provide the content list to a second user associated with the server system, wherein the providing of the content list is based on one or more of:
an indication by the second user of a selection to follow the first user,
a match between user search criteria specified by the second user and at least some of the data associated with the first user,
a match between list search criteria specified by the second user and at least some of the data of the content list, and
a match between the particular user recommendation ranking and ranking criteria specified by the second user.

10. The system according to claim 9, wherein the server system is operable to offer and/or distribute at least some content associated with the content list.

11. The system according to claim 9, wherein the server system is operable to store the content list in a database maintained or accessed by the server system.

12. The system according to claim 9, wherein the server system is operable to assign the particular user recommendation ranking to the first user.

13. The system according to claim 9, wherein the server system is operable to determine the particular user recommendation ranking.

14. The system according to claim 13, wherein the server system is operable to determine the particular user recommendation ranking based on one or more of:
information related to the first user, or feedback information pertaining to the first user that is provided by one or more other users.

15. The system according to claim 9, wherein the server system is operable to distribute a particular content to the second electronic device in response to a request for the particular content.

16. The system according to claim 15, wherein the particular content is selected by the second user, via the second electronic device, based on the distributed content list.

17. A system, comprising:
an electronic device that is operable to obtain from a server system, a content list that is generating using a second electronic device by a user of the second electronic device, and which comprises data related to a plurality of content recommended, used, or reviewed by the user of the second electronic device, wherein the content list is distributed to the second user based on one or more of:
an indication by the second user of a selection to follow the first user,
a match between user search criteria specified by the second user and at least some of the data associated with the first user,
a match between list search criteria specified by the second user and at least some of the data of the content list, and
a match between the particular user recommendation ranking and ranking criteria specified by the second user.

18. The method according to claim 16, wherein the electronic device is operable to obtain a selection, by a user of the electronic device, of a particular content that is available or offered for distribution.

19. The system of claim 17, wherein the particular content is selected by the user of the electronic device based on the content list obtained from the server system.

20. The system of claim 17, wherein the electronic device is operable to obtain the selected content from the server system.

21. A system, comprising:
a server system that is configured to manage sharing of content related data, wherein the server system is operable to generate a content list recommendation that is configured for a user associated with the server system based on one or more requests by the user to follow a particular content list.
